(19) United States
(12) Patent Application Publication
(10) Pub. No.: US 2003/0092319 A1
(43) Pub. Date: May 15, 2003

(54) Optical transceiver module

(76) Inventor: Chen-Hung Hung, Chia-Yi Hsien (TW)

Correspondence Address: DOUGHERTY & TROXELL, Suite 1404, 5205 Leesburg Pike, Falls Church, VA, 22041, US

(21) Appl. No.: 09/987,060

(22) Filed: Nov. 13, 2001

(51) Int. Cl. H01R 13/648

(52) U.S. Cl. 439/607

(57) ABSTRACT

An optical transceiver module comprises an upper casing, a lower casing, a circuit board element in the interior of the lower casing, and an optical receiving connector and an optical transmitting connector internal the circuit board element. The upper and lower casing is combined with respective isolating elements. Thereby, the optical transceiver module is isolated from electromagnetic interference.

### FIELD OF THE INVENTION

The present invention relates to an optical transceiver module, and especially to an optical transceiver module for isolating electromagnetic interference effectively, enhancing the strength of the upper casing and lower casing.

### BACKGROUND OF THE INVENTION

Referring to FIGS. 1 and 2, a prior optical transceiver module is illustrated. The optical transceiver module 1 of the present invention includes an upper casing 2, a lower casing 3 and a circuit board element 4. The circuit board element 4 is connected to an optical receiving connector 5 and an optical transmitting connector 6 for being inserted by a fiber connector. Thus, an optic coupling connection is formed. The light beam from the optical transmitting connector 6 is focused to the center of the fiber.

Since the prior upper casing 2 and lower casing 3 must take the electromagnetic interference into consideration. Thereby, the upper casing 2 and lower casing 3 must be made with material having preferred ability for preventing electromagnetic interference. Therefore, the cost is high and the manufacturing process is complex. In another prior art, the upper casing 2 and lower casing 3 are made of plastics, while they are plated. However, plating process can not afford preferred isolating effect and thus can not afford preferred electric property. isolating effect and thus can not afford preferred electric property.

### SUMMARY OF THE INVENTION

Accordingly, the primary object of the present invention is to provide an optical transceiver module comprising an upper casing, a lower casing, a circuit board element in the interior of the lower casing, and an optical receiving connector and an optical transmitting connector internal the circuit board element. The upper and lower casing is combined with respective isolating elements. Thereby, the optical transceiver module is isolated from electromagnetic interference.

The optical transceiver module of the present invention causes an isolating element to be combined to a casing and has the following advantages: 1. Isolate electromagnetic interference effectively. 2. Increase the thickness of the upper casing and lower casing. 3. Prevent deformation of plastics. 4. Reduce cost, since isolating elements are made of metal so that the cost is minimum.

The various objects and advantages of the present invention will be more readily understood from the following detailed description when read in conjunction with the appended drawing.

### BRIEF DESCRIPTION OF THE DRAWINGS

FIG. 1 is a perspective view of a prior art optical transceiver module.

FIG. 2 is an exploded perspective view of the prior optical transceiver module.

FIG. 3 is an exploded perspective view of the optical transceiver module of the present invention.

FIG. 4 is a perspective view of the first isolating element of the present invention.

FIG. 4A is a longitudinal cross section view showing that the first isolating element of FIG. 4 is enclosed in the upper casing.

FIG. 4B is a transversal cross section view showing the first isolating element of FIG. 4 is enclosed in the upper casing.

FIG. 5 is a perspective view of the second isolating element of the present invention.

FIG. 5A is a longitudinal cross section view showing that the second isolating element of FIG. 5 is enclosed in the lower casing.

FIG. 5B is a transversal cross section view showing that the second isolating element of FIG. 5 is enclosed in the lower casing.

FIG. 6 shows the second embodiment of the present invention.

FIG. 7 is an exploded perspective view of the optical transceiver module of FIG. 6.

FIG. 8 shows the third embodiment of the present invention.

FIG. 9 is an exploded perspective view of the optical transceiver module of FIG. 8.

FIG. 10 shows the fourth embodiment of the present invention.

FIG. 11 is an exploded perspective view of the optical transceiver module of FIG. 10.

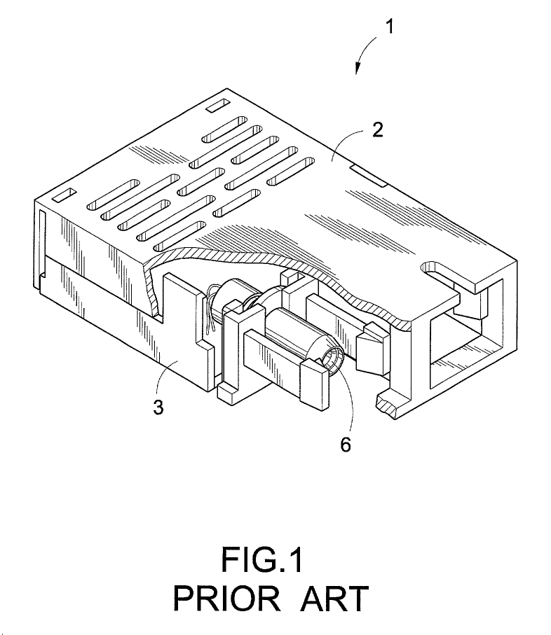

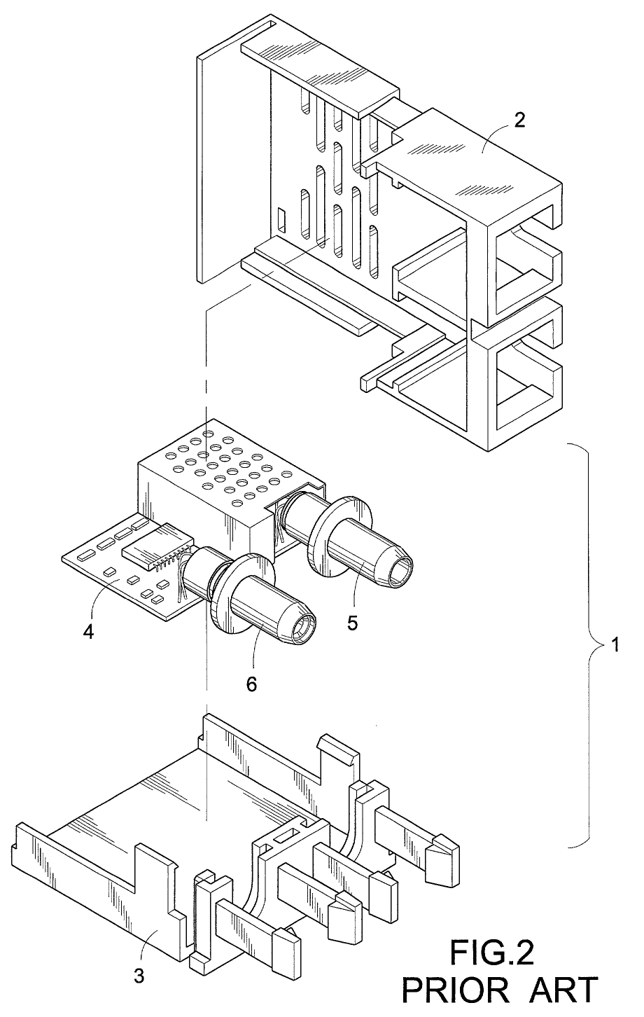

### DETAILED DESCRIPTION OF THE PREFERRED EMBODIMENTS

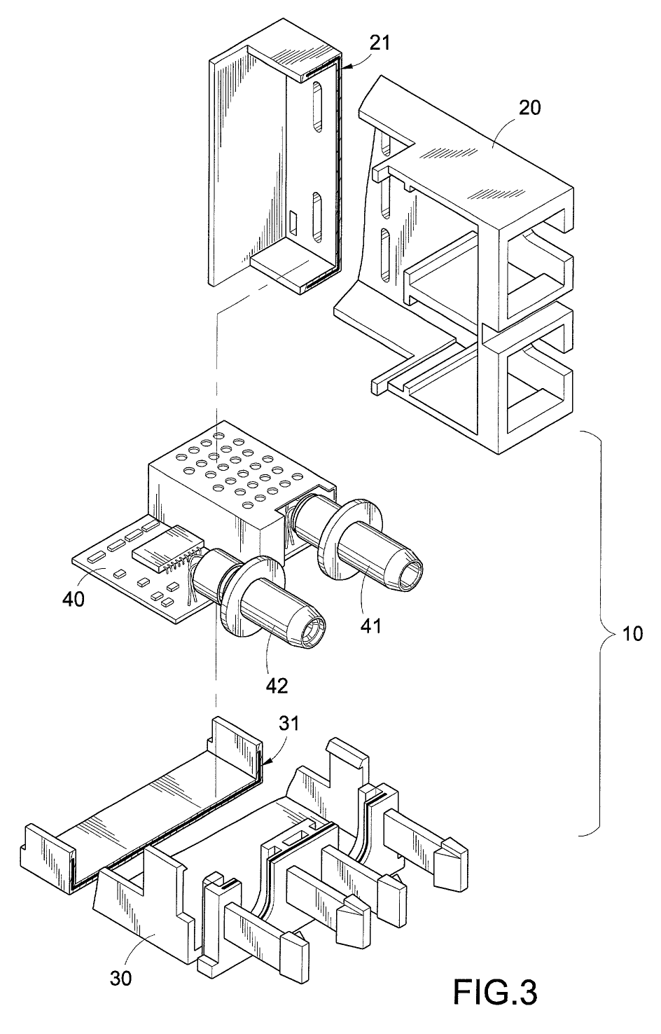

Referring to FIG. 3, the optical transceiver module 10 of the present invention includes an upper casing 20, a lower casing 30 and a circuit board element 40. The circuit board element 40 is connected to an optical receiving connector 41 and an optical transmitting connector 42 for being inserted by a fiber connector. Thus, an optic coupling connection is formed.

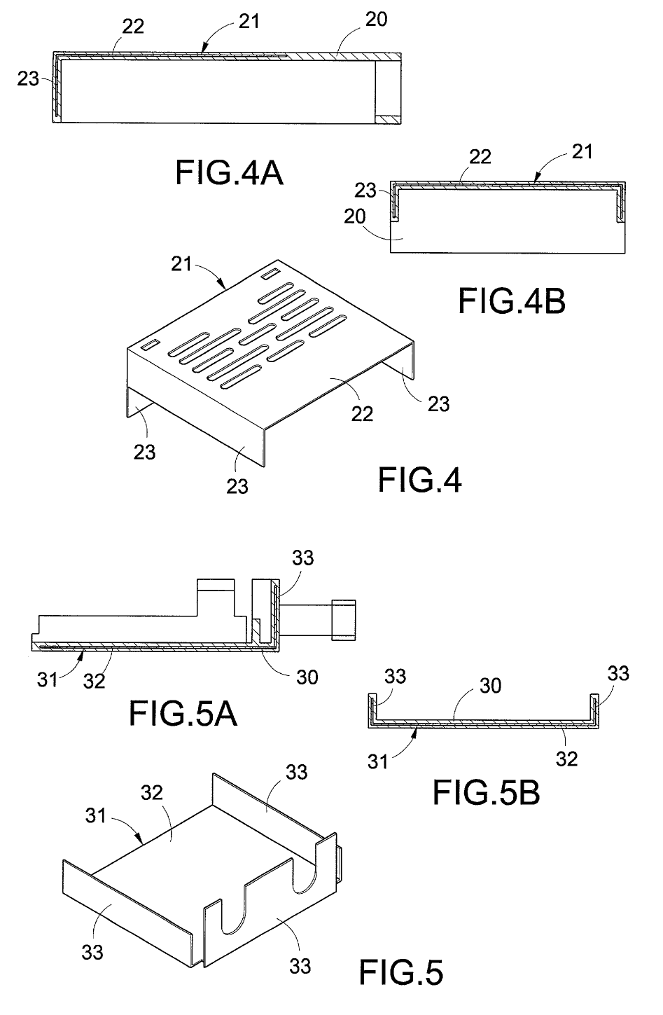

Referring to FIGS. 4, 4A and 4B, a first isolating element is enclosed internal the upper casing 20. The first isolating element 21 is made of thin metal material. The first isolating element has a substrate 22 and three lateral plates 23 which extend downwards from the end portion of the substrate 22. Since the interior of the upper casing 20 encloses the first isolating element so as to isolate electromagnetic interference effectively.

Referring to FIGS. 5, 5A and SB, a second isolating element 31 is enclosed in the lower casing 30. The second isolating element 31 is formed by a thin metal material. The lower casing has a substrate and three lateral plates 33 which extend downwards from the end portion of the substrate 32. Since the interior of the lower casing 30 encloses a second isolating element 31 so as to isolate electromagnetic interference effectively.

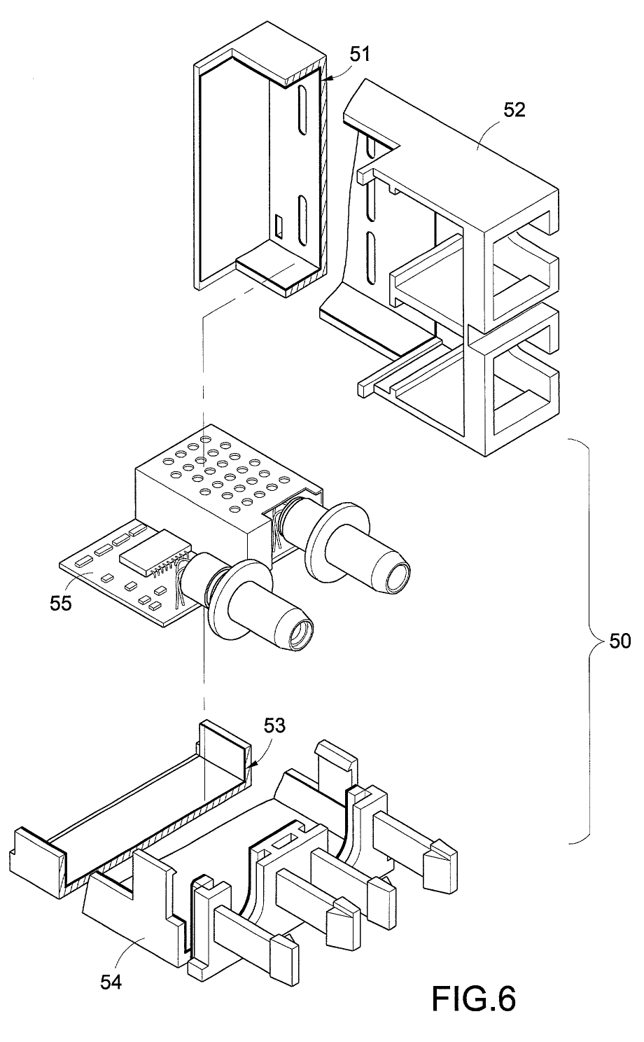

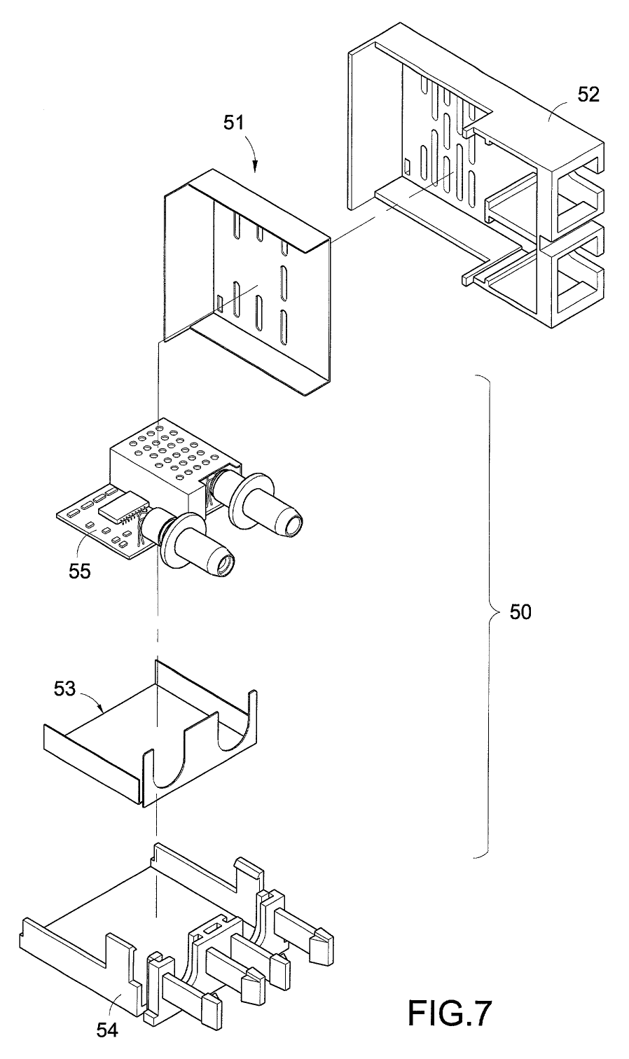

Referring to FIGS. 6 and 7, the second embodiment of the optical transceiver module 10 of the present invention is illustrated. The first isolating element 51 is combined to the interior of the upper casing 52. The second isolating element 53 is combined to the interior of the lower casing 54. Therefore, after assembling the upper casing 52, lower casing 54 and circuit board element 55, electromagnetic interference is isolated effectively.

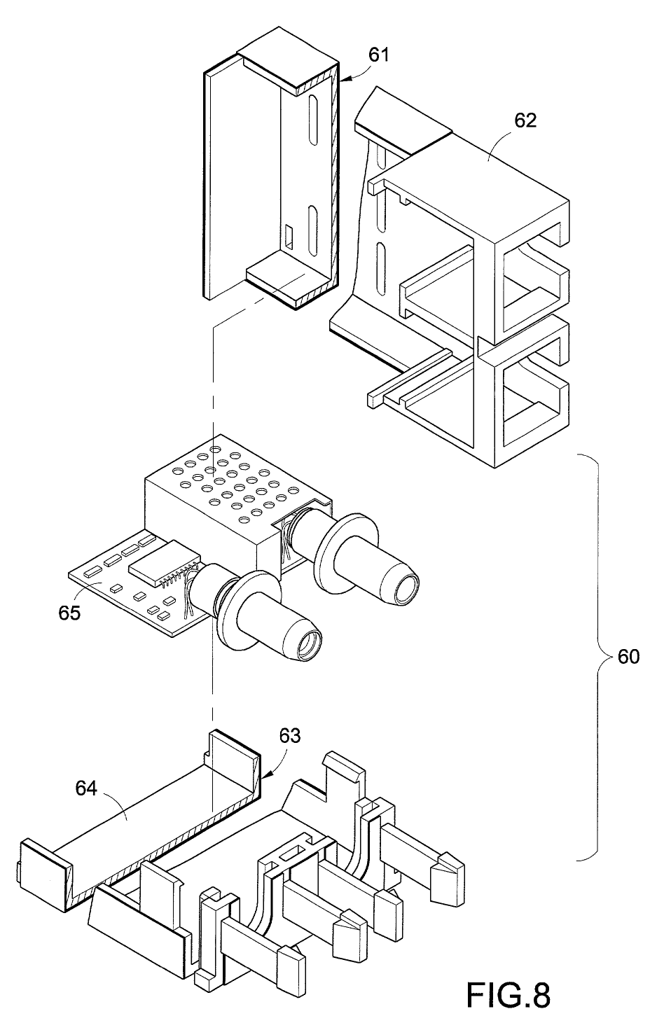

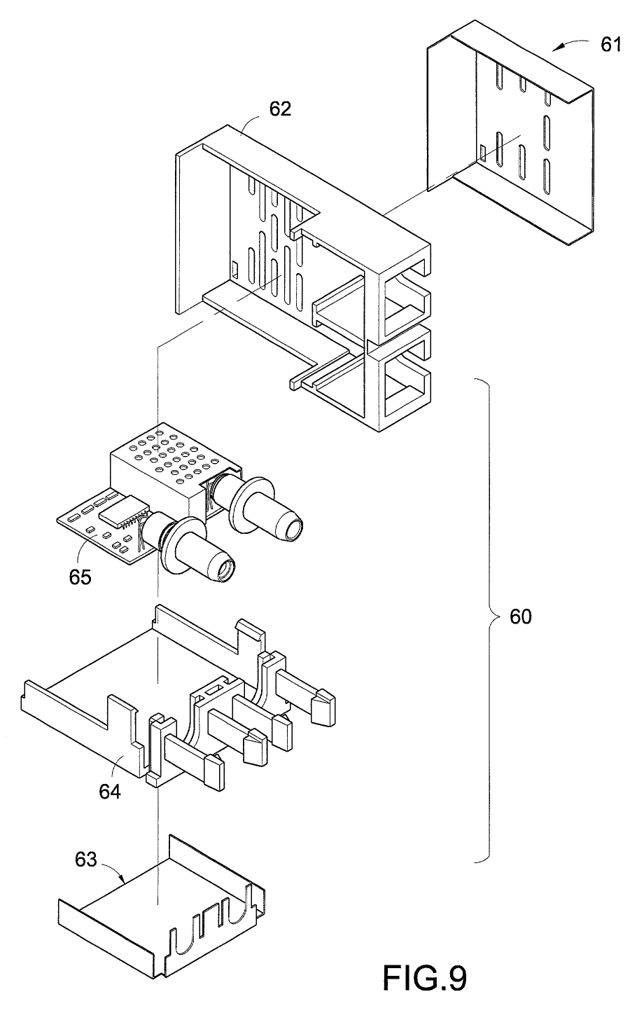

Referring to FIGS. 8 and 9, the third embodiment of the optical transceiver module 10 is illustrated. The first isolating element is combined to the exterior of the upper casing 62, and the second isolating element 63 is combined at the exterior of the lower casing 64 so that after assembling the upper casing 62, lower casing 64 and circuit board element 65, electromagnetic interference is isolated effectively.

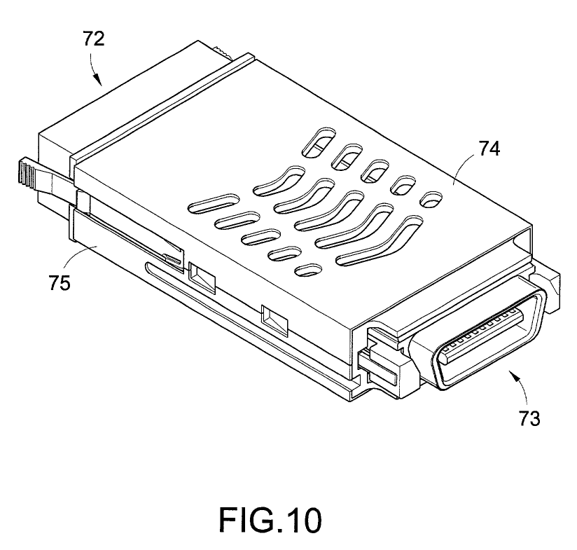

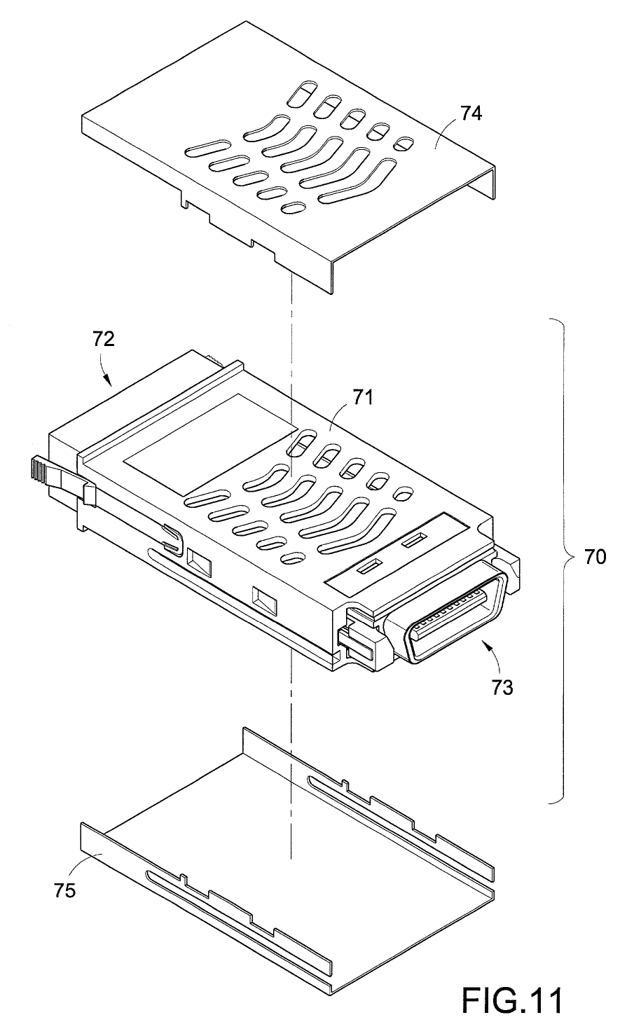

With reference to FIGS. 10 and 11, the fourth embodiment of the optical transceiver module 70 of the present invention is illustrated. The optical transceiver module 70 matches GBIC (Gigabit Interface Converter) and includes a casing 71, and a circuit board element (not shown) is arranged in the casing 71. One end of the circuit board element is connected to an optical receiving connector and an optical transmitting connector so as to be as an optic transceiver connecting end 72. Another end of the circuit board element is formed with a connecting port 73 for being inserted by a female connector so that signals can be transferred.

The upper and lower outer surfaces of the casing 71 are combined with a first isolating element 74 and a second isolating element 75 so that the casing 71 can isolate electromagnetic interference effectively.

The first isolating element 74 and second isolating element 75 are embedded into the interior of the casing 71 or combined to the interior of the casing 71. Similarly, the casing 71 can isolate electromagnetic interference effectively.

In summary, the optical transceiver module of the present invention causes an isolating element to be combined to a casing and has the following advantages:

1. Isolate electromagnetic interference effectively.

2. Increase the thickness of the upper casing and lower casing.

3. Prevent deformation of plastics.

4. Reduce cost, since isolating elements are made of metal so that the cost is minimum.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An optical transceiver module comprising an upper casing, a lower casing, a circuit board element in an interior of the lower casing, and an optical receiving connector and an optical transmitting connector internal the circuit board element; characterized in that:
the upper and lower casing being combined with respective isolating elements, thereby, the optical transceiver module is isolated from electromagnetic interference.

2. The optical transceiver module as claim in claim 1, wherein the isolating elements are embedded in an interior of the upper casing and lower casing, respectively.

3. The optical transceiver module as claim in claim 1, wherein the isolating elements are combined in an interior of the upper casing and lower casing, respectively.

4. The optical transceiver module as claim in claim 1, wherein the isolating elements are combined in an exterior of the upper casing and lower casing, respectively.

5. An optical transceiver module comprising an upper casing, a lower casing, a circuit board element in an interior of the lower casing, and an optical receiving connector and an optical transmitting connector being connected to one end of the circuit board element; and another end of the circuit board element being connected to a connecting port for being inserted by a joint so as to transfer signals of the optical transceiver module; characterized in that:
the upper and lower casing being combined with respective isolating elements, thereby, the optical transceiver module is isolated from electromagnetic interference.
